(19) United States
(12) Patent Application Publication
(10) Pub. No.: US 2024/0392991 A1
(43) Pub. Date: Nov. 28, 2024

(54) METHOD AND SYSTEM FOR A VEHICLE TO BUILDING THERMAL CONTROL SYSTEM

(71) Applicant: FORD GLOBAL TECHNOLOGIES, LLC, Dearborn, MI (US)

(72) Inventors: Stuart C. SALTER, White Lake, MI (US); Ryan O'GORMAN, Beverly Hills, MI (US); Brendan F. DIAMOND, Grosse Pointe, MI (US)

(21) Appl. No.: 18/323,602

(22) Filed: May 25, 2023

(51) Int. Cl. F24F 11/58; F24F 11/54; F24F 11/88

(52) U.S. Cl. CPC F24F 11/58; F24F 11/54; F24F 11/88

(57) ABSTRACT

A method for controlling an HVAC system of a building by a vehicle system associated with a vehicle includes identifying an occupant of the vehicle by the vehicle system, detecting whether a destination of the vehicle having the occupant is the building, obtaining a desired HVAC setting associated with the occupant in response to the destination being the building, defining an HVAC setting for the HVAC system of the building based on the desired HVAC setting associated with the occupant of the vehicle and a HVAC-occupant control algorithm, and transmitting, by the vehicle system, an HVAC building message to an HVAC system of the building to control the HVAC system of the building. The HVAC message includes the HVAC setting for the HVAC system of the building.

### TECHNICAL FIELD

The present disclosure relates to controlling a heat, ventilation, and air conditioning system of a building employing a smart thermostat.

### BACKGROUND

The statements in this section merely provide background information related to the present disclosure and may not constitute prior art.

A building generally includes a heat, ventilation, and air-conditioning (HVAC) system to condition the environment within the building. A smart thermostat can not only be used to monitor and adjust a temperature of the building by controlling the HVAC system, but also provide a user remote access to the HVAC system via a software application associated with the smart thermostat. Accordingly, the user is able to control the HVAC system even when the user is away from the building. In addition, the smart thermostat can provide messages/alerts regarding the conditions of the building to the user via the software application.

### SUMMARY

This section provides a general summary of the disclosure and is not a comprehensive disclosure of its full scope or all of its features.

In one form, the present disclosure is directed to a method for controlling heat, ventilation, and air conditioning (HVAC) of a building by a vehicle system associated with a vehicle. The method includes identifying an occupant of the vehicle by the vehicle system, detecting whether a destination of the vehicle having the occupant is the building, obtaining a desired HVAC setting associated with the occupant in response to the destination being the building, defining an HVAC setting for an HVAC system of the building based on the desired HVAC setting associated with the occupant of the vehicle and a HVAC-occupant control algorithm, and transmitting, by the vehicle system, an HVAC building message to an HVAC system of the building to control the HVAC system of the building. The HVAC message includes the HVAC setting for the building.

In one form, the present disclosure is directed to a system controlling heat, ventilation, and air conditioning (HVAC) of a building by a vehicle system associated with a vehicle. The system includes one or more computing devices configured to: identify an occupant of the vehicle; detect whether a destination of the vehicle having the occupant is the building; obtain a desired HVAC setting associated with the occupant in response to the destination being the building; define an HVAC setting for an HVAC system of the building based on the desired HVAC setting associated with the occupant of the vehicle and a HVAC-occupant control algorithm; and transmit an HVAC building message to control the HVAC system of the building, wherein the HVAC message includes the HVAC setting for the building.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1A illustrates a building having a smart heat, ventilation, and air-conditioning system (S-HVAC) system with a vehicle system in accordance with the present disclosure;

FIG. 1B illustrates an example layout of the building of FIG. 1A having a plurality of independently controlled zones;

FIG. 2 is a block diagram of the S-HVAC system in accordance with the present disclosure;

FIG. 3 is a block diagram of the vehicle system in accordance with the present disclosure;

FIG. 4 is a flowchart of a control routine for a S-HVAC thermal control application in accordance with the present disclosure; and

FIG. 5 is a flowchart of an energy transfer routine for the S-HVAC thermal control application in accordance with the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Increasing energy prices can be related to traditional resources, such as coal and gas, being phased out due to environmental concerns while clean energy sources are gradually being implemented. In addition, with the move to electric vehicles, the demand for electric power may also be on the rise further increasing the price of energy.

In some communities, electric power is maintained at a flat rate regardless of the demand, whereas other communities have implemented dynamic rates that change based on various factors, such as supply and demand. For example, during the summer in Texas, electric power may be cheaper between late night and early morning hours (e.g., 10:00 pm-4:00 am) than between the afternoon and early evening hours (e.g., 12:00 pm to 6:00 pm) due to the demand of powering HVAC systems.

Smart thermostats have been employed in residential and commercial buildings to efficiently control of the HVAC system by activating the system when needed. Some smart thermostats can track the user using a geolocation feature of the portable device having the software application associated with the smart thermostat. And some smart thermostats can also boost efficiency by pre-heating or pre-cooling the building when energy is less expensive.

The present disclosure provides a system/method for a vehicle-to-building thermal control system for controlling an HVAC system in a building. More particularly, a vehicle may include multiple on-board sensors that monitor a location of the vehicle and even monitor occupants within the vehicle. For example, the vehicle may be equipped with a navigation system having a global navigation satellite system (GNSS) configured to track the location and travel time of the vehicle to a selected destination. The vehicle may also be equipped with an interior vision system configured to identify objects/occupants within a passenger cabin of the vehicle employing cameras and facial recognition software.

As detailed herein, identifying an occupant of the vehicle and determining the location of the vehicle relative to the building is employed to manage the HVAC system and thus, the energy consumed by the building. For example, if the occupant of the vehicle is traveling home, desired HVAC settings associated with the occupant may be used to pre-condition the home prior to the occupant arriving.

Other factors may also be used for defining HVAC settings for the HVAC system such as, but not limited to, a length of stay at the building by the occupant (i.e., a potential stay duration), areas within the building that the occupant of the vehicle typically accesses when arriving, and/or whether the building is already being occupied by others before the occupant of the vehicle arrives.

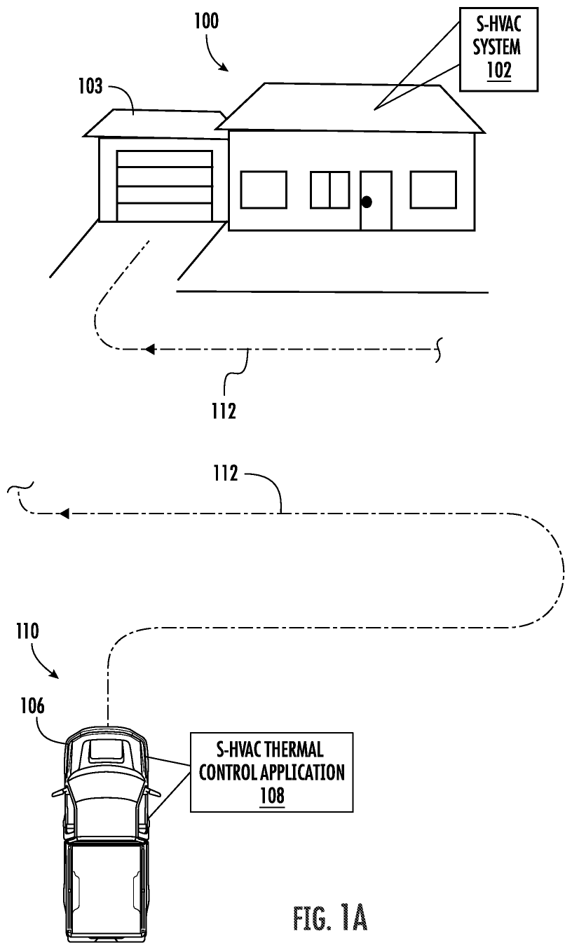

Referring to FIGS. 1A and 1B, a building 100 includes a smart HVAC (S-HVAC) system 102 to control the environmental conditions within the building 100. In a non-limiting example, the building 100 is a house having a garage 103, and thus, the building 100 may be referenced as house 100.

In some applications, the building 100 is defined into a plurality of zones 104A. 104B, 104C (collectively “zones 104”) (FIG. 1B), and the S-HVAC system 102 independently controls the environmental condition of each zone 104. In some applications, the zones 104 may also include the garage 103. While the building 100 is illustrated as a house, it should be readily understood that the building 100 may be another suitable building including, but not limited to, residential, commercial, or industrial use buildings.

In one form, a vehicle 106 and a S-HVAC thermal control application 108 form a vehicle system 110 that is in communication with the S-HVAC system 102 of the building 100. In FIG. 1A, the vehicle 106 is illustrated as traveling to the building 100 via a route 112.

As detailed herein, the vehicle system 110 is configured to define an HVAC setting for the S-HVAC system 102 based on one or more factors. In a non-limiting example, the one or more factors may include: one or more identified occupants in the vehicle 106; one or more identified occupants of the building 100; a desired HVAC setting for the S-HVAC system 102, where the desired HVAC setting is associated with an occupant of the vehicle and/or of the building 100; one or more zones of the building 100 to be occupied by an identified occupant of the vehicle; a travel time of the vehicle 106 to the building 100; a potential stay duration of an identified occupant of the vehicle 106 at the building 100; an energy price rate of electric power from a power grid connected to the building 100; and a vehicle HVAC setting(s) employed for controlling environmental conditions within a passenger cabin of the vehicle 106. In a non-limiting example, the HVAC settings provides a temperature setting, a humidity setting, and/or a fan setting.

The vehicle system 110 and the S-HVAC system 102 are configured to communicate via one or more wireless communication links. In a non-limiting example, the wireless communication links may be established via a cellular network, WI-FI, and/or broad-band communication network. Accordingly, the vehicle system 110 and the S-HVAC system 102 may include hardware components (e.g., routers, transceivers, modems, etc.) and are configured to operate via one or more software protocols.

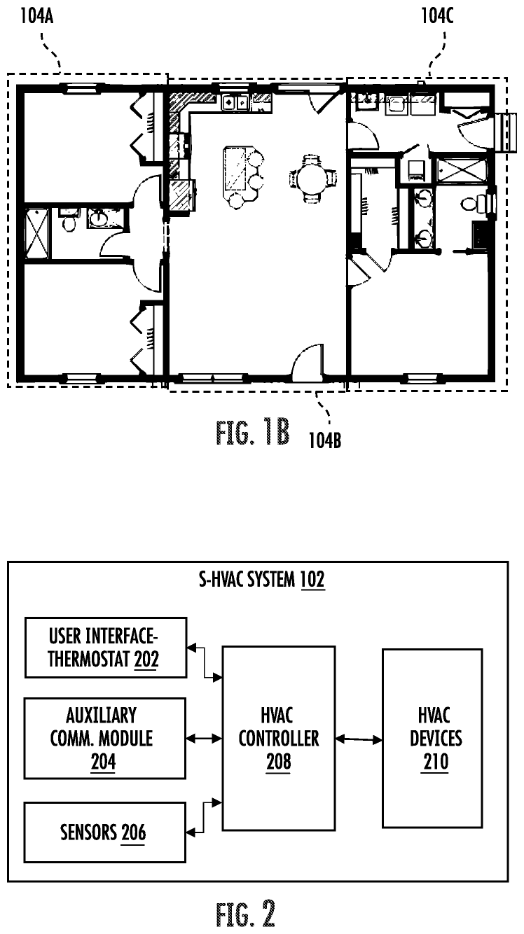

Referring to FIG. 2, in one form, the S-HVAC system 102 includes a user interface thermostat 202, an auxiliary communication module 204, sensors 206 disposed in the building 100, a HVAC controller 208, and one or more HVAC devices 210.

The user interface thermostat 202 is provided in the building 100 to receive inputs from and/or display information to a user/occupant of the building 100. In a non-limiting example, the user interface thermostat 202 includes a touch-screen display, one or more dials operable by the user, and/or an audio system for verbally communicating with the user. In one form, the user interface thermostat 202 is a smart thermostat. Accordingly, the user is able to control the S-HVAC system 102, such as, but not limited to, setting a temperature for a particular zone, and/or turning the S-HVAC system 102 ON or OFF via a physical thermostat or remotely. In addition, the user is able to obtain information regarding the S-HVAC system 102, such as but not limited to: temperature setpoints for the building 100, energy price rates, and/or amount of energy being consumed. In some applications, more than one building user interface thermostat 202 may be provided in the building 100.

The auxiliary communication module 204 is configured to wirelessly communicate with external devices to receive inputs, such as HVAC settings, and provide information regarding the S-HVAC system 102. The external devices may include a software application associated with S-HVAC system 102 that is stored and executed on a user's computing device; the vehicle system 110; and a manufacturer of the S-HVAC system 102.

The sensors 206 are arranged to monitor one or more environmental conditions in and, in some applications, outside of the building 100. In a non-limiting example, the environmental conditions may include temperature at one or more locations in/outside the building 100, atmospheric pressure, humidity, and/or dew point.

The HVAC controller 208 is configured to operate the HVAC devices 210 to control the environmental condition of the building 100 in accordance with the HVAC settings. In a non-limiting example, the HVAC devices 210 includes a furnace, an air-conditioning unit, fans, and/or a humidifier.

As described herein, in one form, the HVAC controller 208 is configured to receive data related to the HVAC settings from the vehicle system 110. Employing predefined HVAC software programs that use the HVAC setting, data from the sensors 206, and/or data from the user interface thermostat 202 as inputs, the HVAC controller 208 controls the operation of the HVAC devices 210.

In the event the vehicle system 110 does not provide the HVAC settings, the HVAC controller 208 is configured to define the HVAC settings employing one or more software programs. That is, in one form, the HVAC controller 208 operates the HVAC devices 210 in accordance with different modes providing different conditioning levels of the building 100. For example, the HVAC controller 208 is configured to include an eco-mode that maintains the temperature of the building 100 at cooler/hotter temperatures to reduce the amount of energy being consumed. Other HVAC modes may be used by the HVAC controller 208 and should not be limited to the example provided herein.

In the present disclosure, the vehicle system 110 not only provides a mode of transportation in the form of the vehicle, but also provides access to the S-HVAC system 102 of the building 100 via the S-HVAC thermal control application 108. The S-HVAC thermal control application is a software application defined to employ systems of the vehicle 106 to generate HVAC setting for the S-HVAC system 102.

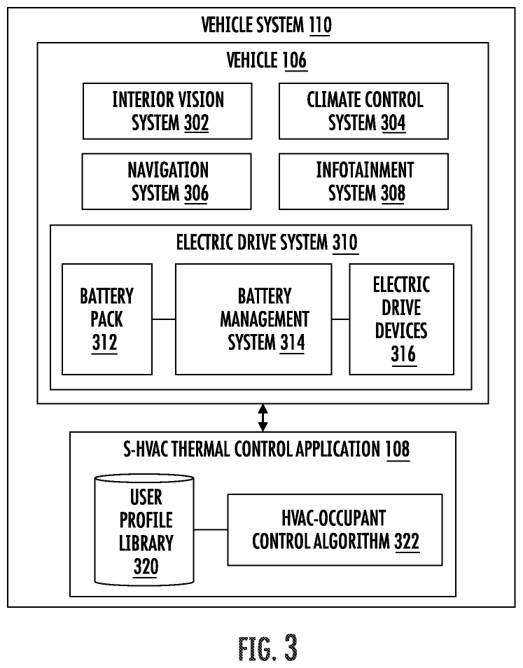

Referring to FIG. 3, among other systems/devices, the vehicle 106 includes an interior vision system 302, a climate control system 304, a navigation system 306, and an infotainment system 308.

The interior vision system 302 is configured to monitor a passenger cabin of the vehicle 106 using one or more cameras (not shown) arranged in the vehicle 106. In one form, the interior vision system 302 is configured to detect and identify occupants within the vehicle 106 using known image processing techniques. For example, the interior vision system 302 obtain images of the passenger cabin and determines whether there is an occupant in the passenger cabin using an image processing software application. In some applications, the image processing software application is configured to employ object detection techniques and/or facial recognition techniques for detecting the occupant and obtaining facial characteristics of the occupant.

The climate control system 304 is configured to control the environmental condition of the passenger cabin of the vehicle 106 and may obtain data related to the environmental conditions such as temperatures within the passenger cabin and outside of the vehicle 106. In a non-limiting example, the climate control system 304 may include a climate control controller for monitoring environmental conditions of the passenger cabin and controlling various vehicle HVAC devices, such as a compressor, radiator, fans, blower, evaporator, and/or condenser.

In one form, the navigation system 306 is configured to track a location of the vehicle 106, define a travel route 112 for the vehicle 106 based on a desired destination of the vehicle 106, provide directions to the desired destination based on the travel route defined, and estimate travel time of vehicle 106 to the desired destination. In a non-limiting example, the navigation system 306 includes a GNSS, a map library, and/or navigation algorithms for defining the travel route.

In one form, the infotainment system 308 is provided to exchange information with an occupant of the vehicle 106. In a non-limiting example, the infotainment system 308 includes an infotainment controller configured to display information to the occupant via devices such as, but not limited to, an audio system, a touchscreen, and/or head-up display.

In some applications, the vehicle 106 may be provided as an electric vehicle having an electric drive system 310. Among other components, the electric drive system 310 may include a battery pack 312, a battery management system 314, and electric drive devices 316 (e.g., electric motors, inverters, transmission). Among other tasks, the battery management system 314 is configured to monitor state of charge of the battery pack 312 and estimate travel range of the vehicle 106 based on the state of charge. An example of a range prediction method is provided in U.S. Pat. No. 11,145,141 titled: ELECTRIC VEHICLE PREDICTIVE RANGE ESTIMATING SYSTEMS AND METHODS, which is assigned to the applicant of the present disclosure and the disclosure of which is incorporated herein as reference.

In some application, the vehicle 106 being an electric vehicle may be a bidirectional energy transfer system that can provide energy to the building 100. An example of a bidirectional energy transfer system is provided in US Pat. App. Pub. No. 2023/0104157 titled: BIDIRECTIONAL ENERGY TRANSFER SYSTEMS AND METHODS FOR PROVIDING ENHANCED HOUSEHOLD TRANSIENT LOAD SUPPORT, which is assigned to the applicant of the present disclosure and the disclosure of which is incorporated herein as reference.

In one form, the S-HVAC thermal control application 108 is stored and executed by a portable computing device 300 of the occupant of the vehicle 106. In addition to or in lieu of being stored in the portable computing device 300 of the occupant, the S-HVAC thermal control application 108 is stored and executed by a controller of the vehicle 106.

The S-HVAC thermal control application 108 is configured to exchange information with the vehicle 106 and define the HVAC settings for the S-HVAC system 102. Prior to defining the HVAC settings, the S-HVAC thermal control application 108 obtains authorization to communicate with and control the S-HVAC system 102 of the building 100. In a non-limiting example, the user of the S-HVAC thermal control application 108 inputs information regarding S-HVAC system 102 and the vehicle 106 associated with the S-HVAC thermal control application 108 and employs dual factor authentication to confirm authorization. The S-HVAC system 102 information may include an address of the building 100, a unique identification code associated with the S-HVAC system 102, and/or other suitable information for identifying the S-HVAC system 102 to be controlled. In a non-limiting example, information related to the vehicle 106 may include at least one of: a license plate of the vehicle 106, picture of one or more users that may operate the vehicle 106, a vehicle-identification-number (VIN), make/model of the vehicle 106.

In one form, the S-HVAC thermal control application 108 includes a user profile library 320 and a HVAC-occupant control algorithm 322. The user profile library 320 is configured to store data related one or more users of the vehicle 106. Specifically, a user of the vehicle 106 may generate a profile including information to identify the user (e.g., a picture of the user) and to define preferences of the user. In a non-limiting example, the information may include: a name of the user; a picture of the user; rooms/zones of the building 100 that is typically accessed by the user; one or more desired HVAC settings or if applicable, for the rooms/zones preferred by the user, where the HVAC settings may be provided as specific values or a range of values; a schedule identifying events that the user may be attending at a particular time and a location of the event; for multiple users, a priority level of the user to identify who's HVAC setting preferences is to be used if more than one user is to be in the building 100 at the same time. Accordingly, the user profile library 320 may store information related to a set of registered users (i.e., one or more registered users) that are associated with the vehicle 106.

In some applications, if the user profile does not include a schedule, the S-HVAC thermal control application 108 may learn the user's behavior over time to define a predicted schedule for the user profile. For example, the S-HVAC thermal control application 108 may track the day, time, and/or destinations of the user when the user is an occupant of the vehicle 106.

In a non-limiting example, the user may generate the profile using an infotainment system 308 of the vehicle 106, or with a series of graphical user interfaces displayed on the portable computing device 300 having the S-HVAC thermal control application 108.

In some applications, the user profile library 320 is provided at a cloud based server accessible to the S-HVAC thermal control application 108 via wireless communication with the server.

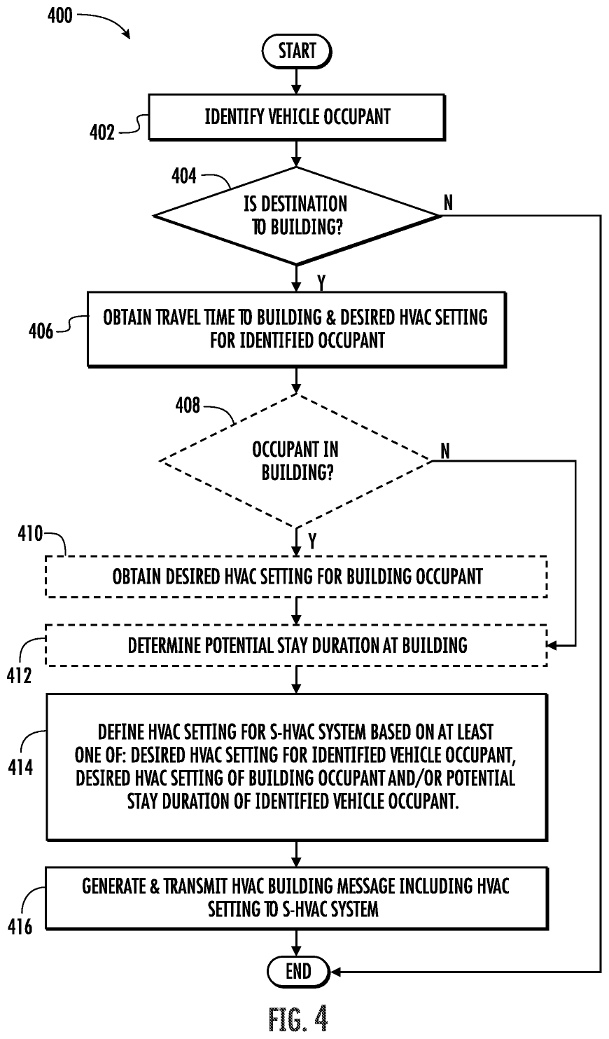

The HVAC-occupant control algorithm 322 defines a series of rules for defining the HVAC setting for the S-HVAC system 102 based on information from the vehicle 106 and information in the user profile library 320. More specifically, referring to FIG. 4, an example control routine 400 for S-HVAC thermal control application 108 having the HVAC-occupant control algorithm 322 is provided. The routine 400 may be executed when the vehicle 106 is turned ON. In routine 400, dashed icons indicate steps that may be omitted by the S-HVAC thermal control application 108.

At operation 402, the application 108 identifies an occupant in the vehicle 106 (i.e., a vehicle occupant). Specifically, the application 108 may request the interior vision system 302 to provide data related to one or more occupants detected by the interior vision system 302, and compares the data provided in the user profile library 320. In a non-limiting example, the data from the interior vision system 302 is indicative of characteristics for facial recognitions, and the application 108 compares the data with images of registered users provided in the user profile library 320. Accordingly, the application 108 may identify the occupant of the vehicle 106 as a registered user selected from among a set of registered users associated with the vehicle 106.

At operation 404, the application 108 determines whether a destination of the vehicle 106 is the building 100. In some variations, the application 108 receives information, such as an address of the destination, from the navigation system 306 of the vehicle 106 to determine if the destination is the building 100. In another variations, if the profile of the user identified include a predicted schedule, the application 108 may determine if the destination is the building 100. That is, if the user profile indicates that the user generally goes to the building 100 at 5:00 pm, and the time is 4:45 pm, the application 108 may predict that the destination is the building 100.

At operation 406, if the destination is the building 100, the application 108 obtains a travel time to the building 100 and a desired HVAC setting associated with identified vehicle occupant. In one form, the travel time to the building can be provided by the navigation system 306 of the vehicle 106. In a non-limiting example, the application 108 may also obtain other information related to the identified vehicle occupant such as, but not limited to, zones within the building 100 that the identified vehicle occupant prefers and/or a priority ranking.

At operation 408, the application 108 determines if the building 100 includes any occupants that are also registered users of the vehicle 106. For example, employing cameras in the building 100, the S-HVAC system 102 may analyze the images using known facial recognition techniques to identify potential occupants in the building 100 and transmit information related to identified occupants, such as a name, to the application 108. In another example, if each registered user of the vehicle 106 has the application 108, the application 108 of the occupant of the vehicle 106 can determine if the other users associated with the vehicle 106 are at the building 100 via a location of the portable computing device 300 associated with the other users.

At operation 410, if there is an occupant in the building 100 (i.e., a building occupant), the application 108 obtains the desired HVAC setting and other information related the building occupant from the user profile library 320. If multiple occupants are identified in the building 100, the application 108 obtains the desired HVAC setting and other information related to the identified occupant from the user profile library 320.

At operation 412, the application 108 determines a potential stay duration at the building 100 for the vehicle occupant identified. Stated differently, while the occupant of the vehicle 106 be going to the building 100, the occupant may be at the building 100 for a short period of time that may warrant different conditioning than when the occupant is to be at the building 100 for a longer period of time. For example, the occupant may be going to the building 100 for less than an hour before having to leave the building 100. The potential stay duration may be determined based on the schedule or predicted schedule of the occupant.

At operation 414, the application 108 defines the HVAC setting based on the HVAC-occupant control algorithm 322 and, at least on, desired HVAC setting for identified vehicle occupant, desired HVAC setting of building occupant, and/or potential stay duration of identified vehicle occupant. The following provides non-limiting examples of different factors considered by the HVAC-occupant control algorithm 322 for defining the HVAC setting. In the examples provided, the HVAC setting is described with respect to the building 100, and if the building 100 includes multiple zones 104, the HVAC setting may include settings for one or more identified zones 104. In addition, the various examples can be taken individually or combined with each other.

In some examples, the HVAC-occupant control algorithm 322 is configured to define the HVAC setting based on the desired HVAC setting and preferences of the identified vehicle occupant. For example, if the vehicle occupant spends time in the kitchen (i.e., a preferred zone 104) when arriving at the building 100, the HVAC setting identified the kitchen as the desired location to be conditioned and the HVAC setting for the location is based on the desired HVAC setting of the occupant.

In some applications, if more than one occupant is identified in the vehicle 106, the HVAC-occupant control algorithm 322 is configured to define the HVAC setting based on the occupant having a higher priority ranking than other occupants identified in the vehicle 106.

In some applications, if one or more occupants are in the building 100, the HVAC-occupant control algorithm 322 is configured to define the HVAC setting based on the desired HVAC setting of each building occupant, the desired HVAC setting of each vehicle occupant, and/or priority rankings of each occupant.

In some applications, if the potential stay duration is equal to or less than a stay threshold, the HVAC-occupant control algorithm 322 is configured to define the HVAC setting based on a minimal conditioning setting. For example, for a hot day, the minimal conditional setting may define the temperature setting at a higher value than that of the desired HVAC setting associated with the occupant.

In some applications, based on the travel time, the HVAC-occupant control algorithm 322 is configured to define the HVAC setting to have the building 100 conditioned to the define HVAC setting by the time the vehicle occupant arrives at the building 100. That is, the algorithm 322 may define a ramp HVAC setting and a steady-state HVAC setting, where the ramp HVAC setting conditions the building 100 to the steady-state HVAC setting by the time the vehicle 106 arrives at the building 100.

In some applications, if the garage 103 is an independent zone 104 of the building 100, the HVAC-occupant control algorithm 322 is configured to define a HVAC setting for the garage 103 based on conditions outside of the garage 103. When the vehicle 106 is in the garage 103, the S-HVAC system 102 is configured to maintain the temperature to a desired setpoint based on outside conditions. In addition, if the vehicle 106 is in the garage 103 and is an electric vehicle, the application 108 may transmit battery temperature information to the S-HVAC system 102 allowing the S-HVAC system 102 to control temperature of the garage 103 based on battery temperature setpoints.

At operation 416, once the HVAC setting is defined, the application 108 generates and transmits a HVAC building message to the S-HVAC system 102, where the message at least includes the HVAC setting. Once received, the S-HVAC system 102 may start conditioning the building 100 based on the HVAC settings provided in the message.

In some examples, the application 108 may routinely transmit messages to the S-HVAC system 102 to provide an update on how far the vehicle 106 is from the building 100 (e.g., the vehicle 106 is X-miles or Y-minutes away from the building 100). Accordingly, the S-HVAC system 102 may determine when to begin preconditioning the building 100.

Other factors may also be employed by the application 108 for defining the HVAC setting. For example, the application 108 may define the HVAC setting based on energy price rates which can be provided by the S-HVAC system 102. Accordingly, if the price of energy is higher at the time the vehicle 106 is traveling to the building 100, the HVAC-occupant control algorithm 322 to configured define the HVAC settings to reduce energy consumption.

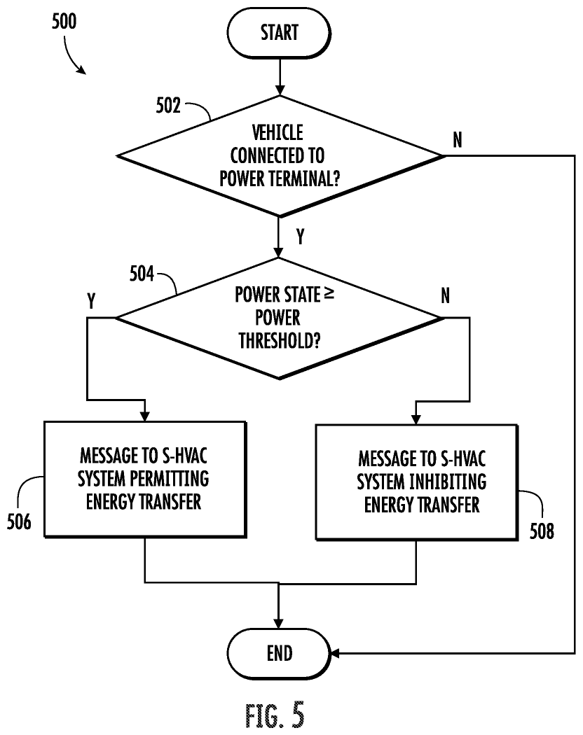

In the event the vehicle 106 is an electric vehicle with bidirectional energy transfer, energy from the vehicle 106 may be used to condition the building 100. More particularly, referring to FIG. 5, an example energy transfer routine 500 performed by the S-HVAC thermal control application 108 is defined to determine when the vehicle 106 may be used as an energy source for the S-HVAC system 102.

At operation 502, the S-HVAC thermal control application 108 detects whether the vehicle 106 is electrically connected to a power terminal of the building 100. In one form, the application 108 may determine this based on data from the battery management system 314.

At operation 504, if the vehicle 106 is connected to the power terminal, the S-HVAC thermal control application 108 determines whether a power state of the battery pack 312 is greater than or equal to a power threshold for providing electric power to the building 100. The power state may be the state of charge of the battery pack 312.

If the power state is greater than or equal to the power threshold, the S-HVAC thermal control application 108, at operation 506, transmits a message to the S-HVAC system 102 permitting energy transfer. That is, the HVAC devices 210 may be powered by the vehicle 106. Accordingly, the S-HVAC system 102 may selectively control the HVAC device 210 of the building 100 using electric power from the vehicle 106 based an occupant of the building 100, where the occupant of the building 100 may include the occupant identified in the vehicle 106.

If the power state is less than the power threshold, the S-HVAC thermal control application 108 transmits a message the S-HVAC system 102 inhibiting power transfer, at operation 508. In other words, the vehicle 106 may not be used to provide energy to the HVAC devices 210.

The description of the disclosure is merely exemplary in nature and, thus, variations that do not depart from the substance of the disclosure are intended to be within the scope of the disclosure. Such variations are not to be regarded as a departure from the spirit and scope of the disclosure. Additionally, the features of various implementing embodiments may be combined to form further embodiments.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

What is claimed is:

1. A method for controlling heat, ventilation, and air conditioning (HVAC) of a building by a vehicle system associated with a vehicle, the method comprising:
identifying an occupant of the vehicle by the vehicle system;
detecting whether a destination of the vehicle having the occupant is the building;
obtaining a desired HVAC setting associated with the occupant in response to the destination being the building;
defining an HVAC setting for an HVAC system of the building based on the desired HVAC setting associated with the occupant of the vehicle and a HVAC-occupant control algorithm; and
transmitting, by the vehicle system, an HVAC building message to the HVAC system of the building to control the HVAC system of the building, wherein the HVAC message includes the HVAC setting for the HVAC system of the building.

2. The method of claim 1, further comprising, with the vehicle at the building:
detecting that the vehicle is electrically connected to a power terminal of the building; and
selectively controlling the HVAC system of the building using electric power from the vehicle based on an occupant of the building in response to a power state of a battery of the vehicle being greater than or equal to a power threshold for providing the electric power to the building, wherein the occupant of the building includes the occupant identified in the vehicle; and
controlling the HVAC system of the building using electric power from power grid in response to the power state of the battery being less than the power threshold.

3. The method of claim 1, wherein the HVAC setting defines a temperature setting, a humidity setting, a fan setting, or a combination thereof.

4. The method of claim 1, further comprising determining a potential stay duration of the occupant of the vehicle at the building based on a schedule associated with the occupant identified in the vehicle, wherein the HVAC setting is further defined based on the potential stay duration.

5. The method of claim 1, further comprising controlling the HVAC of the building based on the HVAC message from the vehicle by the HVAC system.

6. The method of claim 1, wherein:
the building is defined into a plurality of zones that are independently controllable from one another, and
the HVAC setting identifies a zone from among the plurality of zones and defines a temperature setting for the zone based on a user profile associated with the occupant of the vehicle.

7. The method of claim 1, wherein the building is defined into a plurality of zones that are independently controllable from one another, and one of the zones is a garage of the building, wherein the method further comprises:
detecting the vehicle in the garage; and
controlling a temperature of the garage based on a current temperature of the garage in response to the vehicle being detected in the garage.

8. The method of claim 1, further comprising:
identifying an occupant in the building; and
obtaining prioritization rankings associated with the occupant in the building and the occupant of vehicle, wherein:
the HVAC setting is defined based on a selected occupant having a higher prioritization ranking from among the occupant of the vehicle and the occupant of the building.

9. The method of claim 1, wherein the identifying the occupant of the vehicle by the vehicle system further comprises:
obtaining images of a passenger cabin of the vehicle by an interior vision system of the vehicle;
determining that the occupant is in the passenger cabin using an image processing software application; and
identifying the occupant as a registered user selected from among a set of registered users associated with the vehicle.

10. The method of claim 1, further comprises estimating, by the vehicle system, a travel time to the building in response to the destination being the building, wherein the HVAC building message includes the travel time.

11. The method of claim 1, wherein the HVAC-occupant control algorithm defines the HVAC setting based on at least one of:
a travel time of the vehicle to the building,
a desired HVAC setting of an occupant at the building,
a potential stay duration of the occupant of the vehicle at the building,
an energy rate of electric power from a power grid, or
a vehicle HVAC setting of the vehicle.

12. A system controlling heat, ventilation, and air conditioning (HVAC) of a building by a vehicle system associated with a vehicle, the system comprising:
one or more computing devices configured to:
identify an occupant of the vehicle;
detect whether a destination of the vehicle having the occupant is the building;
obtain a desired HVAC setting associated with the occupant in response to the destination being the building;
define an HVAC setting for the HVAC system of the building based on the desired HVAC setting associated with the occupant of the vehicle and a HVAC-occupant control algorithm; and
transmit an HVAC building message to control the HVAC system of the building, wherein the HVAC message includes the HVAC setting for the HVAC system of the building.

13. The system of claim 12, wherein the one or more computing devices are further configured to:
detect that the vehicle is electrically connected to a power terminal of the building; and
selectively control the HVAC system of the building using electric power from the vehicle based on an occupant of the building in response to a power state of a battery of the vehicle being greater than or equal to a power threshold for providing the electric power to the building, wherein the occupant of the building includes the occupant identified in the vehicle.

14. The system of claim 12, wherein the HVAC setting defines a temperature setting, a humidity setting, a fan setting, or a combination thereof.

15. The system of claim 12, wherein the one or more computing devices are further configured to determine a potential stay duration of the occupant of the vehicle at the building based on a schedule associated with the occupant identified in the vehicle, wherein the HVAC setting is further defined based on the potential stay duration.

16. The system of claim 12, wherein the one or more computing devices are further configured to control the HVAC of the building based on the HVAC message from the vehicle.

17. The system of claim 12, wherein:
the building is defined into a plurality of zones that are independently controllable from one another, and one of the zones is a garage of the building, and
the one or more computing devices are further configured to:
detect the vehicle in the garage; and
control a temperature of the garage based on a current temperature of the garage in response to the vehicle being detected in the garage.

18. The system of claim 12, wherein the one or more computing devices are further configured to:
identify an occupant in the building; and
obtain prioritization rankings associated with the occupant in the building and the occupant of vehicle, wherein: the HVAC setting is defined based on a selected occupant having a higher prioritization ranking from among the occupant of the vehicle and the occupant of the building.

19. The system of claim 12, wherein to identify the occupant of the vehicle, the one or more computing devices are further configured to:
obtain images of a passenger cabin of the vehicle by an interior vision system of the vehicle;
determine that the occupant is in the passenger cabin using an image processing software application; and
identify the occupant as a registered user selected from among a set of registered users associated with the vehicle.

20. The system of claim 12, wherein the HVAC-occupant control algorithm defines the HVAC setting based on at least one of:
a travel time of the vehicle to the building,
a desired HVAC setting of an occupant at the building,
a potential stay duration of the occupant of the vehicle at the building,
an energy rate of electric power from a power grid, or
a vehicle HVAC setting of the vehicle.
